(19) United States
(12) Patent Application Publication
(10) Pub. No.: US 2016/0105089 A1
(43) Pub. Date: Apr. 14, 2016

(54) Linear Vibrator

(71) Applicant: NOKIA CORPORATION, Espoo (FI)

(72) Inventors: Shengrong Shi, San Diego, CA (US); Yuanjia Yang, Beijing (CN)

(21) Appl. No.: 14/889,262

(22) PCT Filed: May 9, 2013
(86) PCT No.: PCT/CN2013/075415

§ 371 Date: Nov. 5, 2015

(51) Int. Cl. H02K 33/02; H02K 15/02; H02K 33/00

(52) U.S. Cl. CPC H02K 33/02; H02K 33/00; H02K 15/02

(57) ABSTRACT

An apparatus comprising: a resonance module located within a resonator frame, the resonance module comprising at least two integrated conductive suspension parts, the at least two integrated conductive suspension parts being configured to couple the resonance module to the frame, and further configured to provide a current through the resonance module, wherein the at least two integrated conductive suspension parts enable the resonance module to resonate.

### FIELD

The present application relates to linear vibrator apparatus. The application further relates to, but is not limited to, linear vibrators for use in portable or mobile apparatus.

### BACKGROUND

Vibrators or vibras have been typically used within mobile apparatus or devices to provide a haptic alert or signal. For example the vibrator or vibra can cause an apparatus to vibrate to provide a silent alert when a call or message is being received. Similarly in some situations a display element of the apparatus can be vibrated by the vibrator to provide haptic feedback when the display is touched or activated in some manner by the user.

Some example implementations of vibrators in such apparatus is a direct current (DC) motor with an eccentrically mounted mass which vibrates the apparatus when activated. However linear vibrators are becoming more popular in mobile devices or apparatus. Linear vibrator performance improves over the motor vibrator especially in touch apparatus haptic signal applications as the linear vibrator can generate good haptic ‘feeling’ and quick response times.

A linear vibrator typically comprises a single resonator formed by a mass and spring and is driven by a linear sinusoidal force. Although the linear vibrator has a big advantage in performance compared with DC motor, and additionally usually has fewer wearing components leading to the linear vibrator having a better mean time to failure the price of the linear vibrator is typically much higher than the DC motor vibrator and therefore too expensive to be implemented into low cost phones. Furthermore the complex structure of the linear vibrator means that not only the bill of materials (BOM) cost is high but production is usually performed on a semi-automatic production line and therefore the labor cost is also very high.

Furthermore current linear vibrators do not produce true linear performance because of non-linear forces being applied.

### SUMMARY OF THE APPLICATION

Aspects of this application thus provide linear resonance.

There is provided an apparatus comprising: a resonance module located within a resonator frame, the resonance module comprising at least two integrated conductive suspension parts, the at least two integrated conductive suspension parts being configured to couple the resonance module to the frame, and further configured to provide a current through the resonance module, wherein the at least two integrated conductive suspension parts enable the resonance module to resonate.

The at least two integrated conductive suspension parts may be further configured to be mechanically resilient in at least a direction substantially perpendicular to the direction of the current such that the resonance module is configured to have a static resting position.

The resonance module may comprise at least one integrated suspension part configured to couple the module to the frame.

The resonance module may be a unitary body.

The resonance module may comprise: a conductive part; and a non-conductive part, wherein a combined weight of the conductive and non-conductive part is a resonance weight.

The apparatus may further comprise: a resonator frame; and a conductive coil wrapped around the resonator frame and configured to generate a magnetic field in a first direction within the frame when an alternating current passes through the coil; and wherein the current passes through the resonance module in a second direction, the second direction at least partially perpendicular to the first direction, and the at least two integrated conductive suspension parts are mechanically resilient in a third direction substantially perpendicular to the first and the second directions such that the resonance module can be configured to resonate in the third direction based on the interaction of the magnetic field in the first direction and the current in the second direction.

The frame may comprise at least two connectors configured to couple the at least two integrated conductive suspension parts to a peripheral frame element.

The apparatus may further comprise: a series resistor; a switch; and a direct current voltage supply coupled via the series resistor and switch in series to the at least two parts to provide an intermittent current to drive the suspension module to resonate.

The apparatus may further comprise: a surround configured to partially surround and mechanically protect the resonance module, wherein the surround may comprise: an open box casing to substantially enclose the resonance module; and a printed wiring board box lid.

The printed wiring board box lid may comprise at least two conductive pads, and the at least two conductive pads may be coupled to at least one of: at least two integrated conductive suspension parts to couple the resonance module and provide a current through the resonance module; and a conductive coil wrapped around the resonator frame configured to generate a magnetic field within the frame when an alternating current passes through the coil.

According to a second aspect there is provided a method comprising: providing a resonance module located within a resonator frame, the resonance module comprises providing at least two integrated conductive suspension parts, coupling the at least two integrated conductive suspension parts to the frame, and providing a current through the resonance module, wherein the at least two integrated conductive suspension parts enable the resonance module to resonate.

Providing at least two integrated conductive suspension parts may comprise providing mechanically resilient at least two integrated conductive suspension parts in at least a direction substantially perpendicular to the direction of the current such that the resonance module has a static resting position.

Providing the resonance module may comprise providing at least one integrated suspension part to mechanically couple the resonance module to the frame.

Providing the resonance module may comprise providing a unitary body resonance module.

Providing the resonance module may comprise: providing a conductive part; and providing a non-conductive part, wherein a combined weight of the conductive and non-conductive part is a resonance weight.

The method may further comprise: providing a resonator frame; and providing a conductive coil wrapped around the resonator frame and configured to generate a magnetic field in a first direction within the frame when an alternating current passes through the coil; and wherein the current passes through the resonance module in a second direction, the second direction at least partially perpendicular to the first direction, and the at least two integrated conductive suspension parts are mechanically resilient in a third direction substantially perpendicular to the first and the second directions such that the resonance module can be configured to resonate in the third direction based on the interaction of the magnetic field in the first direction and the current in the second direction.

Providing the resonator frame may comprise providing at least two connectors configured to couple the at least two integrated conductive suspension parts to a peripheral frame element.

The method may further comprise: providing a surround configured to partially surround and mechanically protect the resonance module, wherein providing the surround comprises: providing an open box casing to substantially enclose the resonance module; and providing a printed wiring board box lid.

Providing the printed wiring board box lid may comprise providing at least two conductive pads, and the at least two conductive pads are coupled to at least one of: at least two integrated conductive suspension parts to couple the resonance module and provide a current through the resonance module; and a conductive coil wrapped around the resonator frame configured to generate a magnetic field within the frame when an alternating current passes through the coil.

According to a third aspect there is provided an apparatus comprising: a resonance means located within a frame means, the resonance means comprising at least two integrated conductive suspension means, the at least two integrated conductive suspension means being configured to couple the resonance means to the frame means, and further configured to provide a current through the resonance means, wherein the at least two integrated conductive suspension means enable the resonance means to resonate.

The at least two integrated conductive suspension means may be mechanically resilient in at least a direction substantially perpendicular to the direction of the current such that the resonance means has a static resting position.

The resonance means comprises at least one integrated suspension means configured to couple the module to the frame.

The resonance means may be a unitary body.

The resonance means may comprise: a conductive part; and a non-conductive part, wherein a combined weight of the conductive and non-conductive part is a resonance weight.

The apparatus may further comprise: a resonator frame; and a conductive coil wrapped around the resonator frame and configured to generate a magnetic field in a first direction within the frame when an alternating current passes through the coil; and wherein the current passes through the resonance means in a second direction, the second direction at least partially perpendicular to the first direction, and the at least two integrated conductive suspension means are mechanically resilient in a third direction substantially perpendicular to the first and the second directions such that the resonance means can be configured to resonate in the third direction based on the interaction of the magnetic field in the first direction and the current in the second direction.

The frame may comprise at least two connectors configured to couple the at least two integrated conductive suspension means to a peripheral frame element.

The apparatus may further comprise: a series resistor; a switch; and a direct current voltage supply coupled via the series resistor and switch in series to the at least two parts to provide an intermittent current to drive the resonance means to resonate.

The apparatus may further comprise: surround means configured to partially surround and mechanically protect the resonance means, wherein the surround means comprises: an open box casing to substantially enclose the resonance module; and a printed wiring board box lid.

The printed wiring board box lid may comprise at least two conductive pads, and the at least two conductive pads are coupled to at least one of: at least two integrated conductive suspension means to couple the resonance means and provide a current through the resonance means; and a conductive coil wrapped around the resonator frame configured to generate a magnetic field within the frame when an alternating current passes through the coil.

Embodiments of the present application aim to address problems associated with the state of the art.

### SUMMARY OF THE FIGURES

For better understanding of the present application, reference will now be made by way of example to the accompanying drawings in which:

FIG. 1 shows a schematic view of an apparatus suitable for implementing embodiments;

FIG. 2 shows schematically a prior art linear vibrator;

FIG. 3 shows schematically a sectioned view of an example linear vibrator according to some embodiments;

FIG. 4 shows schematically the magnetic field generated by a coil within the example linear vibrator according to some embodiments;

FIG. 5 shows schematically an isometric view of an example linear vibrator according to some embodiments;

FIG. 6 shows schematically an isometric view of a component of the example linear vibrator according to some embodiments;

FIG. 7 shows a graph comparing the linear force generated by an example linear vibrator according to some embodiments compared against a non-linear force;

FIG. 8 shows schematically an isometric view of insert metal process fixing the resonance system to the support in the linear vibrator according to some embodiments;

FIG. 9 shows an example electrical circuit suitable for driving the linear vibrator according to some embodiments;

FIGS. 10 and 11 show an example linear vibrator module according to some embodiments; and

FIG. 12 shows schematically an isometric view of a composite component of the example linear vibrator according to some embodiments.

### EMBODIMENTS OF THE APPLICATION

The following describes in further detail suitable linear vibrator apparatus and possible mechanisms for the provision of linear vibration in apparatus.

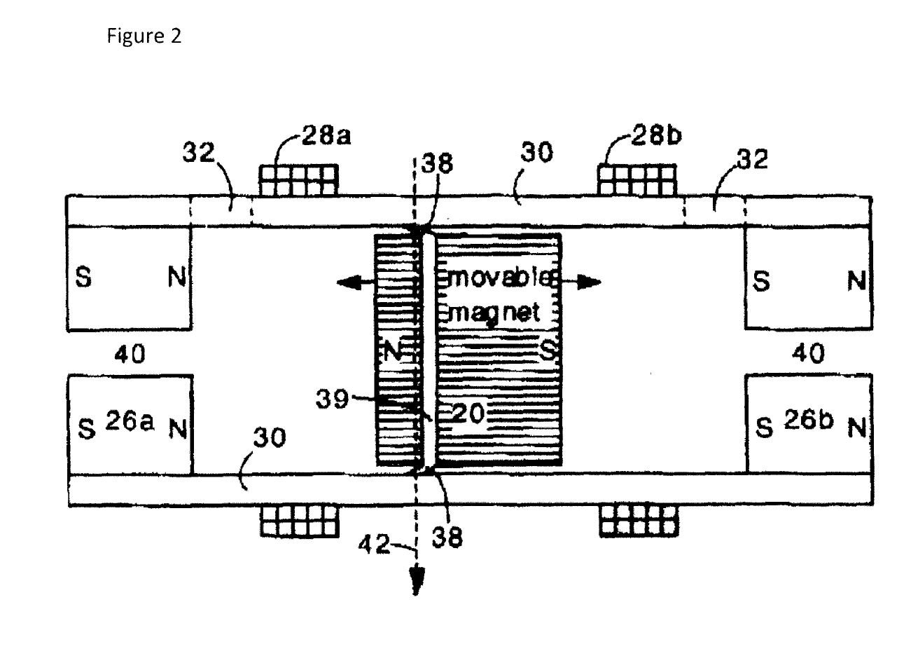

With respect to FIG. 2 a schematic cross sectional view of a prior art linear vibrator is shown. The enclosure can be cylindrical as illustrated, or can be square or can have other cross sectional shape. Preferably, the enclosure 30 is made of a lightweight polymeric material such as polycarbonate. Also preferably, the tubular enclosure has at least one air hole 32 for allowing air to escape and enter the enclosure as the movable magnet 20 oscillates. The enclosure 30 can be perforated with many holes. The air holes 32 reduce viscous friction losses that would otherwise cause damping of the magnet motion. However, in some applications, a valve, e.g., a plate which covers a portion of the air holes 32, may be provided to regulate the resonance of the vibrator wherein higher resonance is achieved with more open air holes and lower resonance is achieved with air holes being partially closed. Further, in some applications the movable magnet will travel along the axial path in a fluid other than air where the fluid fills the housing 30. In addition to the air holes 32 or as an alternative, the bumper magnets 26 can have air vents 40 to allow air to escape and enter the enclosure as the movable magnet 20 oscillates. These air vents 40 could also be equipped with a valve mechanism for controlling vibratory resonance. Also the movable magnet can have air vents in its body or at its side to let air pass from one side of the moveable magnet to the other has it vibrates. The magnets 20 26 are typically high strength rare earth magnets, but the magnets can be made of any magnetic material or magnetizable material. The field coils 28 can comprise conventional copper wire windings; however, other metal or metal alloy windings may be employed. Preferably, the two coaxial field coils 28 are spaced apart by a distance at least as great as an axial length of the movable magnet 20. The field coils can be connected in series or parallel. If the field coils are connected in series, then they should be wound in opposite directions so that they produce anti-parallel magnetic fields. A low viscosity lubricant such as silicone oil can be provided to minimize friction between the movable magnet 20 and the enclosure. The vibrator can have a pickup coil for monitoring the position of the movable magnet 20. Electrical signals induced in the pickup coil by the movable magnet 20 are detected by a sensor circuit and used to control the operation of a field coil driver circuit. The field coil driver circuit can be a conventional amplifier circuit or switching circuit. The vibrator can be attached to a circuit board or other support with adhesive or fasteners such as bolts or screws can be used. In operation, an alternating current is provided in the field coils 28a 28b. Preferably, the field coils 28 are oriented such that they apply push and pull forces to the movable magnet 20. In order to provide push and pull forces, the field coils 28 must have anti-parallel magnetic fields (e.g. field coils can be wound in opposite directions, as noted above). As the movable magnet 20 oscillates under the influence of the field coils 28, it repeatedly rebounds from the magnetic field of the bumper magnets 26. The movable magnet will oscillate the frequencies of the alternating currents applied to the field coils 28. The alternating current applied to the field coils 28 can have a frequency selected to match a mechanical resonance frequency of the movable magnet 20. Alternatively, the alternating current applied to the field coils has a range of frequencies that includes the mechanical resonance frequency of the movable magnet. Typically the resonant frequency and operating frequency will be in the range of about 10-200 Hertz. The movable magnet induces a current in the pickup coil, which is detected by a sensor and used to control the alternating current flowing in the field coils 28. Alternatively, the frequency of the alternating current can be fixed to a value matching or close to a known resonant frequency of the movable magnet. The resonant frequency of the movable magnet 20 depends mainly on the field strength and mass of the movable magnet 20 and the field strength of the bumper magnets 26. Also, as discussed above, air within the enclosure 30 will function as an air spring in embodiments where the air holes 32 are not provided and the movable magnet 20 has a close-tolerance fit inside the enclosure 30. The air spring will tend to increase the resonant frequency of the movable magnet 20. It is noted that the electromagnetic vibrator can be operated such that it has a flat frequency response by feeding back the sensor signal through an electrical control compensator that adjusts the alternating current amplitude to produce a flat response over a broad frequency range. In this case, less power can be provided to the field coils 28 at frequencies near the resonant frequency. With applied power adjusted according to operating frequency, the present vibrator can have a relatively flat frequency response and can be used to provide constant-amplitude vibrations over a wide range of frequencies. The movable magnet 20 is typically heavier than the enclosure and other vibrator components. Minimizing the weight of the enclosure 30 and other components relative to the movable magnet 20 can increase the vibration forces that can be transferred. The field coils 28 are preferably driven by a squarewave signal. A sinusoidal waveform or triangular waveform or any other waveform can also be used. Pulse width modulated signals can also be used to drive the field coils. The movable magnet can be a solid cylindrical magnet (instead of a toroidal magnet), as shown. Also the bumper magnets 26 are toroidal, with air vents 40. The air vents 40 perform the same function as the air holes 32; the air vents 40 allow air to enter and escape the enclosure 30 as the movable magnet 20 oscillates.

In other words a typical electromagnetic vibrator has a movable magnet that can move linearly in an axial direction. The field coil surrounds the movable magnet. Magnetic bumpers are disposed on opposite ends of the vibrator, and are oriented to repel the movable magnet. When an alternating current is provided in the field coil, the movable magnet oscillates linearly in the axial direction, bumping against the magnetic field of the bumper magnets and thereby creating vibration. The movable magnet may have a toroidal shape and be disposed on an axial shaft to linearly constrain the motion of the movable magnet. Two field coils can be provided to simultaneously create push and pull forces on the movable magnet. The bumper magnets can be replaced with compression springs. The electromagnetic vibrator can be very small and energy efficient; it is well suited for use in portable electronic devices, cell phones, toys, industrial mixers, and massage devices

However such designs as shown in FIG. 2 formed by a pair of push-pull driven coils and single magnet have the following disadvantages. Firstly there is no suspension system to have fixed resonance frequency. Secondly as described earlier the linear vibrator has a high cost in material and complexity with double coils and triple magnets. Thirdly the initial position of the magnet is not and cannot be controlled.

The concept as described herein provides a new structure for a linear vibrator. The structure enables low cost production due to compatibility with full automation production and having a simple structure. Furthermore the linear vibrator structure can provide a better performance with more linear driven force.

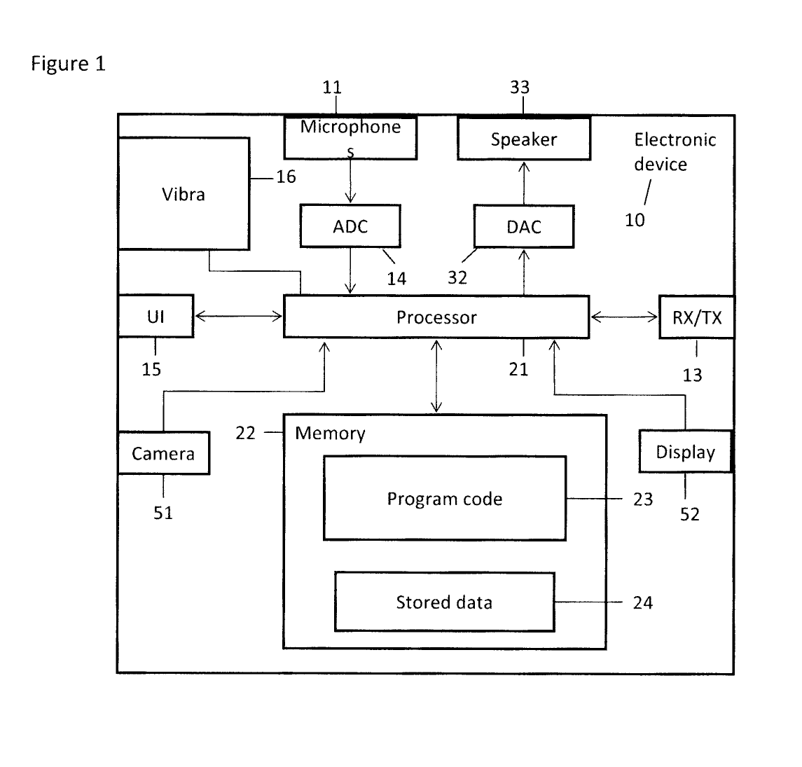

In this regard reference is first made to FIG. 1 which shows a schematic block diagram of an exemplary apparatus or electronic device 10, which may implement a linear vibrator.

The apparatus 10 can for example be a mobile terminal or user equipment of a wireless communication system. In some embodiments the apparatus can be an audio player or audio recorder, such as an MP3 player, a media recorder/player (also known as an MP4 player), or any suitable portable device requiring user interface inputs.

In some embodiments the apparatus can be part of a personal computer system an electronic document reader, a tablet computer, or a laptop.

apparatus 10 can in some embodiments comprise an audio subsystem. The audio subsystem for example can include in some embodiments a microphone or array of microphones 11 for audio signal capture. In some embodiments the microphone (or at least one of the array of microphones) can be a solid state microphone, in other words capable of capturing acoustic signals and outputting a suitable digital format audio signal. In some other embodiments the microphone or array of microphones 11 can comprise any suitable microphone or audio capture means, for example a condenser microphone, capacitor microphone, electrostatic microphone, electret condenser microphone, dynamic microphone, ribbon microphone, carbon microphone, piezoelectric microphone, or microelectrical-mechanical system (MEMS) microphone. The microphone 11 or array of microphones can in some embodiments output the generated audio signal to an analogue-to-digital converter (ADC) 14.

In some embodiments the apparatus and audio subsystem includes an analogue-to-digital converter (ADC) 14 configured to receive the analogue captured audio signal from the microphones and output the audio captured signal in a suitable digital form. The analogue-to-digital converter 14 can be any suitable analogue-to-digital conversion or processing means.

In some embodiments the apparatus 10 and audio subsystem further includes a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can include in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise the audio capture only such that in some embodiments of the apparatus the microphone (for audio capture) and the analogue-to-digital converter are present.

In some embodiments the apparatus audio-video subsystem comprises a camera 51 or image capturing means configured to supply to the processor 21 image data. In some embodiments the camera can be configured to supply multiple images over time to provide a video stream.

In some embodiments the apparatus audio-video subsystem comprises a display 52. The display or image display means can be configured to output visual images which can be viewed by the user of the apparatus. In some embodiments the display can be a touch screen display suitable for supplying input data to the apparatus. The display can be any suitable display technology, for example the display can be implemented by a flat panel comprising cells of LCD, LED, OLED, or ‘plasma’ display implementations.

Although the apparatus 10 is shown having both audio/video capture and audio/video presentation components, it would be understood that in some embodiments the apparatus 10 can comprise only the audio capture and audio presentation parts of the audio subsystem such that in some embodiments of the apparatus the microphone (for audio capture) or the speaker (for audio presentation) are present. Similarly in some embodiments the apparatus 10 can comprise one or the other of the video capture and video presentation parts of the video subsystem such that in some embodiments the camera 51 (for video capture) or the display 52 (for video presentation) is present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals, the camera 51 for receiving digital signals representing video signals, and the display 52 configured to output processed digital video signals from the processor 21.

The processor 21 can be configured to execute various program codes.

In some embodiments the apparatus further comprises a memory 22. In some embodiments the processor 21 is coupled to memory 22. The memory 22 can be any suitable storage means. In some embodiments the memory 22 comprises a program code section 23 for storing program codes implementable upon the processor 21 such as those code routines described herein. Furthermore in some embodiments the memory 22 can further comprise a stored data section 24 for storing data. The implemented program code stored within the program code section 23, and the data stored within the stored data section 24 can be retrieved by the processor 21 whenever needed via a memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the transceiver is configured to transmit and/or receive the audio signals for processing according to some embodiments as discussed herein.

In some embodiments the apparatus comprises a linear vibrator 16.

It is to be understood again that the structure of the apparatus 10 could be supplemented and varied in many ways.

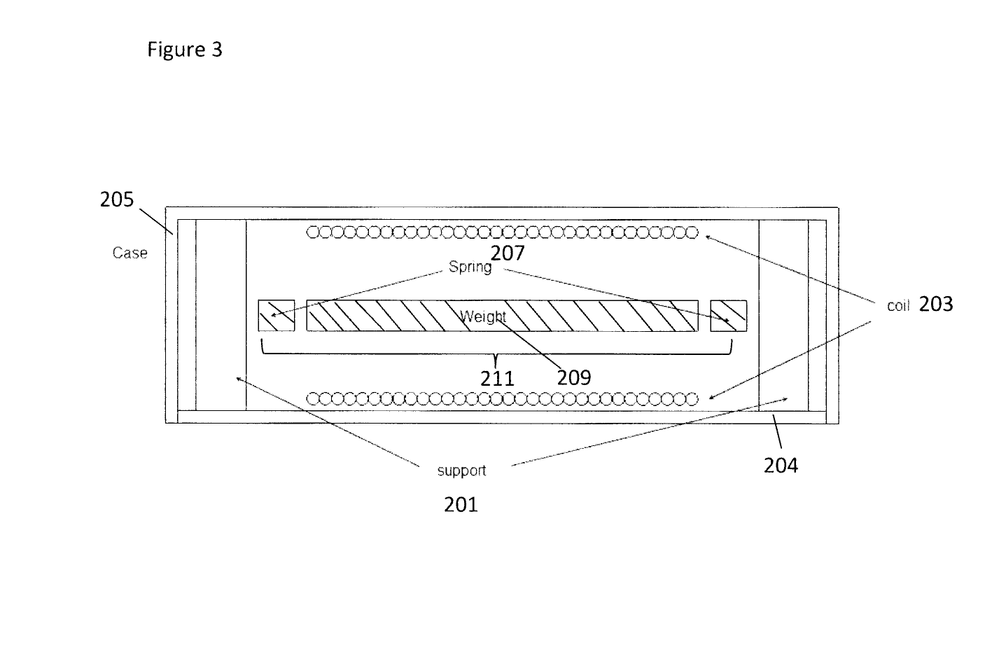

With respect to FIGS. 3, 5, 8 and 6 examples of a linear vibrator are shown according to some embodiments. In these examples the linear vibrator comprises a resonance system which combines a spring, resonance weight and resonance conductor within a single module and therefore to simplify the structure and reduce the total cost. Furthermore the magnetic coil as shown can provide an even magnetic field and the linear vibrator structure shown can utilize this even field as a linear driving force.

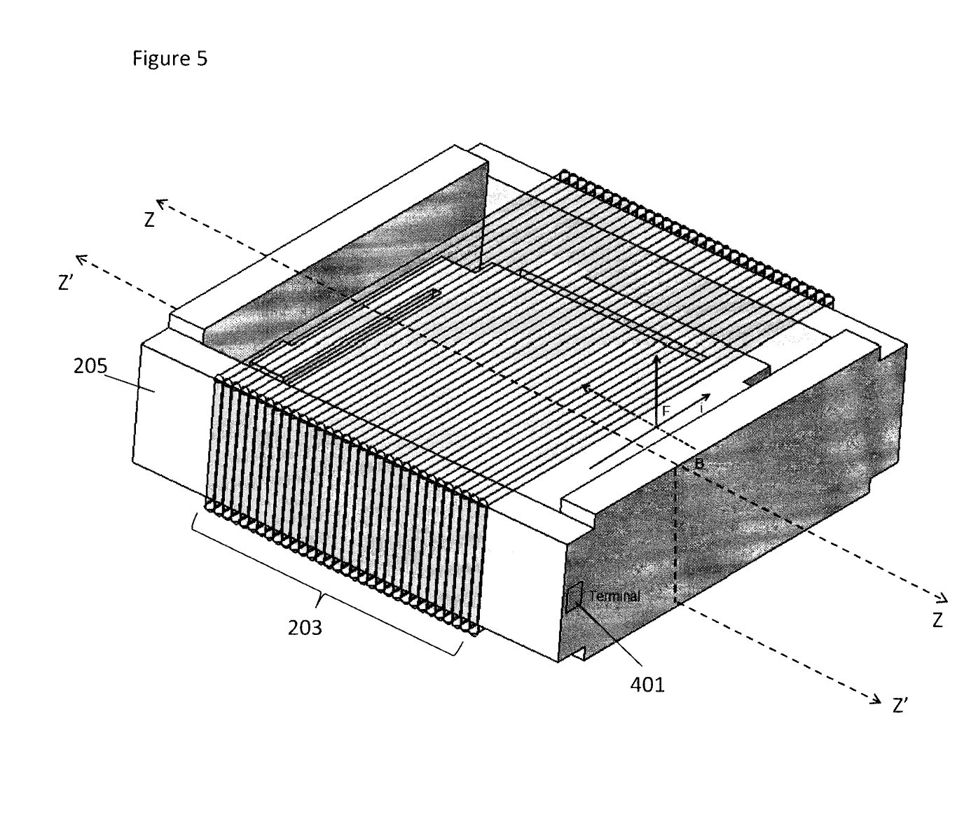

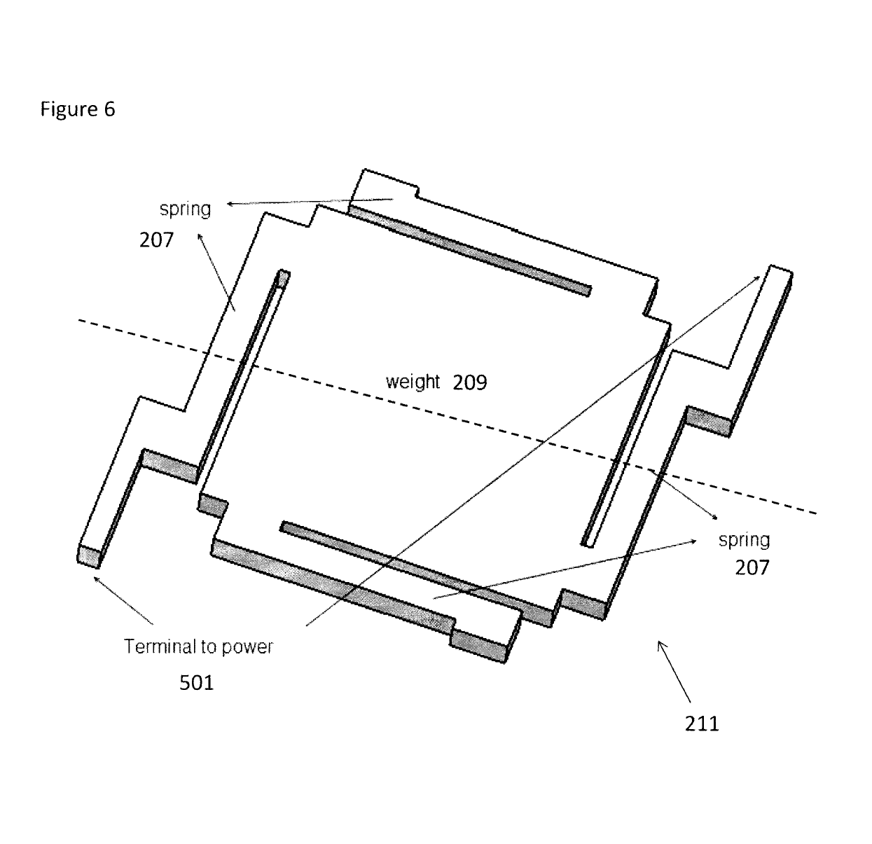

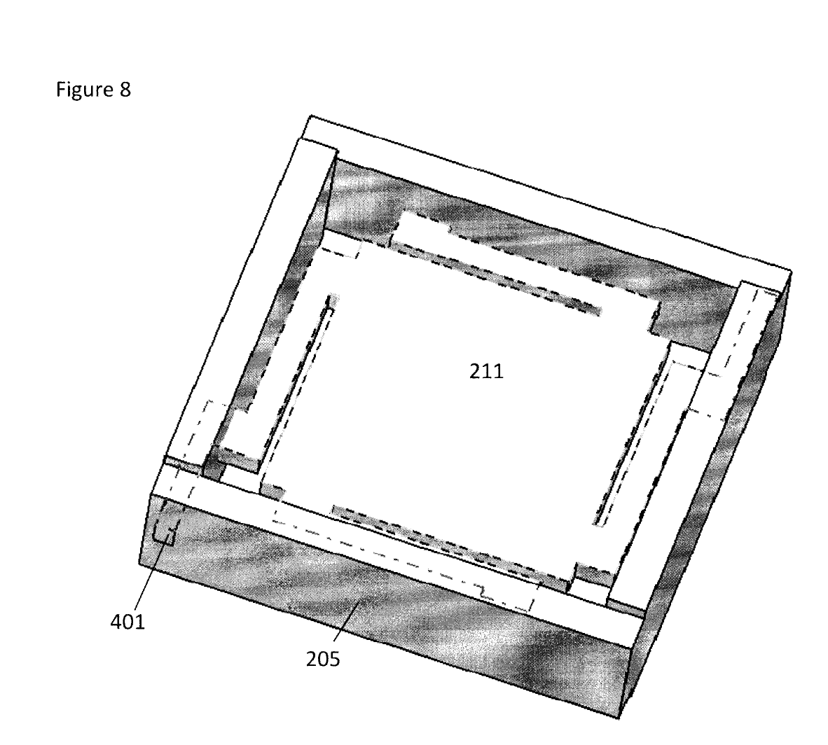

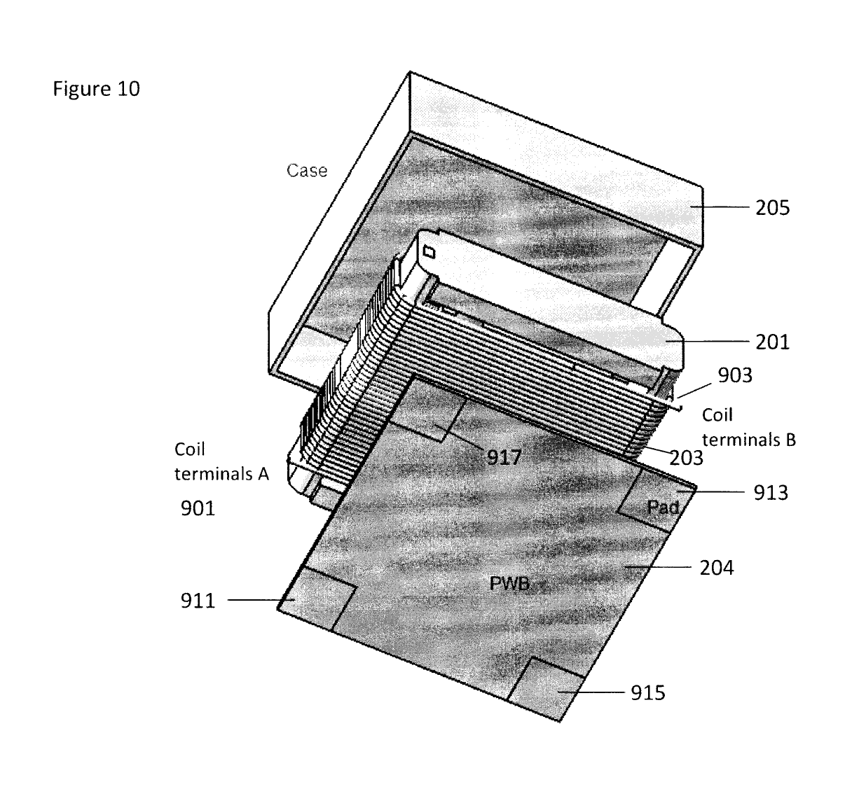

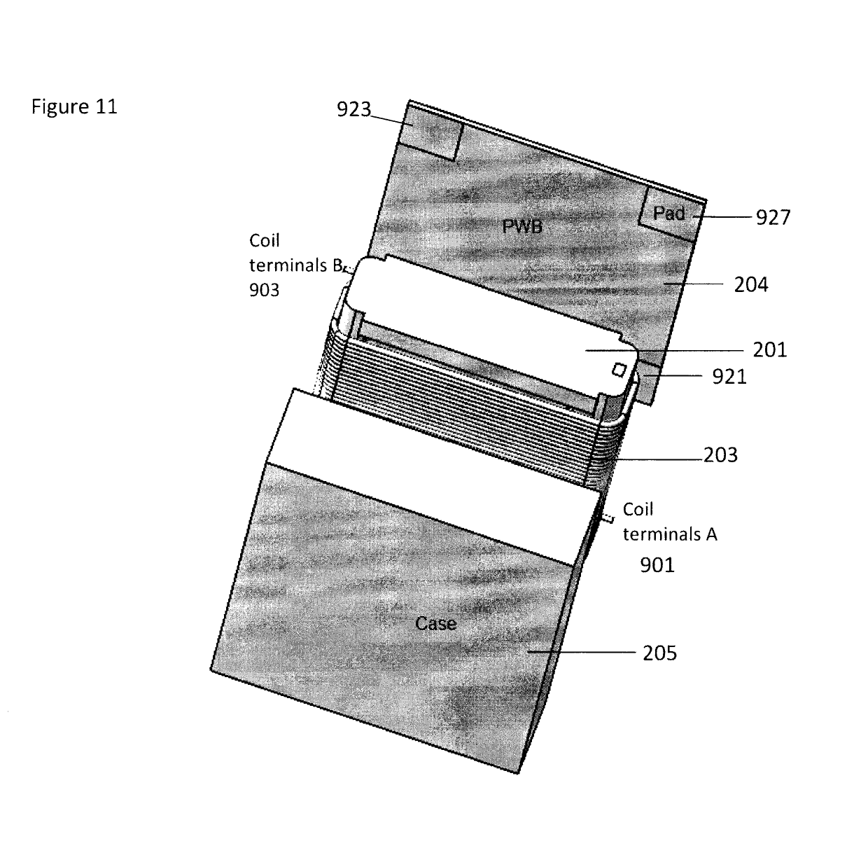

With respect to FIG. 3 a cross-sectional view through the example linear vibrator is shown. The example linear vibrator is further shown in FIGS. 10 and 11 which show exploded isometric projection versions of the linear vibrator configuration. Furthermore with respect to FIG. 5 an isometric projection view of the linear vibrator such as shown in FIG. 3 without casing is shown. Furthermore with respect to FIG. 8 an isometric view of the example linear vibrator as shown in FIG. 5 with coils removed to show the structure of the resonance system within the support. Furthermore with respect to FIG. 6 an example resonance system component is further shown.

As shown in FIG. 3 the linear vibrator comprises a surround comprising an ‘upper’ open box or case 205 and a ‘lower’ lid or PWB 204 which together surrounds and protects the other components of the linear vibrator and assure the connection to the PWB. The expression ‘upper’ and ‘lower’ are relative terms only and it would be understood that in some embodiments the orientation of the case 205 and printed wiring board or PWB 204 can be any suitable orientation.

In some embodiments the PWB can comprise pads, in this example there are four interior pads 921, 923 and 927 (the fourth pad being hidden) which are located ‘inside’ in other words in the direction towards the linear vibrator and four exterior pads 911, 913, 915, and 917 which are located ‘outside’ in other words in the direction away from the linear vibrator. In some embodiments the at least two of the interior pads can be configured to couple to coil terminals, such interior pads 911 and 913 configured to couple to coil terminal A 901 and coil terminal B 903 respectively in order to provide power to the coil 203. This coupling can for example be a soldering or other suitable electrical coupling which can provide some mechanical coupling.

Furthermore in some embodiments at least two further interior pads, for example 915 and 917 can be configured to be coupled to the terminals, such as terminal 401 to provide current to the resonance system 211. In some embodiments the interior pads can be electrically coupled to the exterior pads by suitable vias or through holes. In some embodiments the exterior pads can be mechanically coupled to the main printed wiring board or assembly. For example in some embodiments the exterior pads can be coupled to the main assembly by surface mounting technology (SMT) or contact spring.

The surround and casing can be any suitable material size or configuration. The casing 205 in some embodiments can comprise suitable electrical connections to provide power to the coil 203 and the resonance system 211.

The linear vibrator in some embodiments further comprises a support 201 or cage or frame which is located within the surround (or casing and pwb) 205. The support 201 is configured to support the resonance system 211 and the coil 203.

As can be seen in FIGS. 5 and 8 the support structure 201 or frame comprises a hollow box like structure with two missing faces. In the example linear vibrator shown herein the resonator is a vertical resonator and the hollow box like structure has missing the top and bottom faces and so forms a perimeter wall like structure. Furthermore in the example shown herein two of the walls are taller than the other two walls (such that the shorter of the two walls are suitable for wrapping the coil wires about them without the coils extending or protruding from the structure of the support.

The hollow box (square) like structure for the support is an example only and it would be understood that in some embodiments the shape or configuration can be any suitable structure.

In other words the support 201 or support structure can generally be configured such that it comprises an inner cavity suitable for receiving the resonance system 211 and around which the coil 203 structure is arranged.

In some embodiments the support 201 further comprises at least two terminals 401 (of which one terminal 401 is shown in FIGS. 5 and 8) or electrical connectors is configured to carry current from the outside of the support structure to an inner part of the support structure and the resonance system 211.

In some embodiments the linear vibrator comprises a coil 203. The coil 203 is configured to generate a linear magnetic field along the centre of the coil 203. As can be seen in FIGS. 3 and 5 the coil is formed from multiple loops of wire or other conductive material wrapped around the support 201 to effectively form the two missing faces or sides of the box like structure of the support 201.

The function of coil is to generate an even or linear magnetic field inside the coil. From the Biot-Savart law, the magnetic field generated from a wire with current will follow:

$$d \vec{B} = \frac{{μ}_{0}}{4 π} \cdot \frac{I \cdot d \vec{l} \times \vec{r}}{{r}^{2}}$$

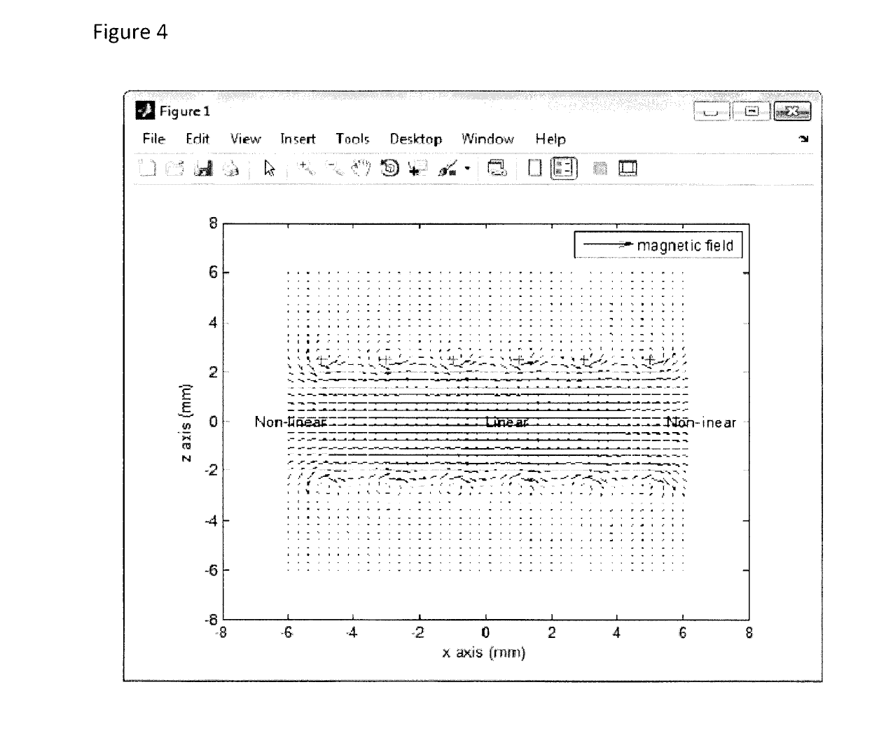

Thus it is possible to calculate the magnetic field generated from the coil 203 by integration and simulate the magnetic field distribution. An example of this can be seen in FIG. 4 which shows the simulated magnetic field inside the coil as being even or linear but outside the simulated magnetic field is non-linear.

In some embodiments the linear vibrator comprises a resonance system or module 211. The resonance system or module 211 comprises a resonance weight 209 or body and is coupled to the support or frame by at least two springs 207 or suspension parts or limbs. The resonance system 211 is located within the coil. In some embodiments the resonance system comprises separate spring and mass components which are joined together. For example in some embodiments the resonance system comprises a well designed spring which has the same shape but is thinner (or thicker) or is a different material to the mass component in order that the resonance system has a defined or designed compliance. The mass component or additional mass element can in some embodiments be fixed on the spring with laser welding or glue.

The spring 207 or limb and resonance weight 209 or body forming the resonance system are integral and can be formed in some embodiments by machining a single component. In other words the body and the at least two limbs are a unitary body. For example in some embodiments the spring and resonance weight are formed from a metal such like steel and can be made as one component by punching process from a blank. For example for a resonance weight Mm=1 g (or 0.001 Kg), the dimension of the weight 209 is approximately 8 mm*8 mm*2 mm when using steel or less than 1 mm when using a separate spring and mass with tungsten material. In some embodiments the resonance system can be machined from any suitable conductive component, for example micromachining a semiconductor.

The spring or springs 207 as shown in FIG. 6 comprises lengths of resilient material which at one end can be connected or coupled to the support 201 and at the other end to the resonance weight 209. In such a manner the spring configuration can support the resonance weight 209 and furthermore determine or define an un-biased or inactive rest position for the weight. In the examples shown, for example as shown in FIG. 6 the weight 209 is supported or located from the support 205 by four springs 207, each spring coupling the weight to one face of the support structure. However it would be understood that there may be more than or fewer than four springs coupling the weight to the support.

In some embodiments at least two of the springs or limbs can further be coupled to an associated terminal 401 within the support 205. In some embodiments the coupling can be formed by extending the spring length to the outer face of the support, in other words the terminal 401 is a hole within the support 205 through which can pass the spring to couple the resonance system 211 to the periphery of the support.

The terminals of spring can in some embodiments be coupled or connected to a power source directly via a serial resistor configured to adjust the current and furthermore a switch.

In other words the resonance system 211 and in particular the resonance weight 209 can be considered to operate as a ‘wire’ through which a current can pass from one side to the other.

The current passing through the resonance weight 209, when the coil 203 is active is also passing through a linear magnetic field. A current passing through a magnetic field experiences a force which follows Ampere's law: F=BLi. In other words where the current is passing perpendicular to the magnetic field then a force can be generated which actuates the resonance weight 209 in a direction perpendicular to the magnetic field and the current and therefore where both the magnetic field and the current are in the horizontal plane then the actuation is in the vertical plane.

For the structure, L (the length of the wire) is fixed with mechanical dimension (for example the mechanical dimension of the resonant weight 209); i (the current passing through the wire) can depend on the serial resister R.

Thus for the resonant system 211, the vibration equation can be described as the following:

$${M}_{m} \cdot \frac{{d}^{2} x}{d {t}^{2}} + {R}_{m} \cdot \frac{d x}{d t} + \frac{1}{{C}_{m}} \cdot x = B \cdot l \cdot {I}_{w}$$

With the simulation results shown in FIG. 4, the magnetic field strength B for the example structure only depends on the coil current while inside the coil; while outside the coil the magnetic field strength B also depends on the distance to the coil.

This can be compared to the prior art system, for example as shown in FIG. 2 where the weight is operating or working in the non-linear area of the magnetic field. The generated force in the prior art system will thus be non-linear due to the distance change when the magnet or coil moves. For example where the weight of the resonance system Mm=0.001 kg; the resistance of the resonance system Rm=0.1 N·s/m; and the compliance of the spring Cm=1000 μm/N; and the force is F=B*I*Iw=0.001*sin(ωt) in the example resonance system structure as described herein while the prior art force F=B*I*Iw varies with the distance x and can be modeled as being F=0.001*(1+x)*sin(ωt).

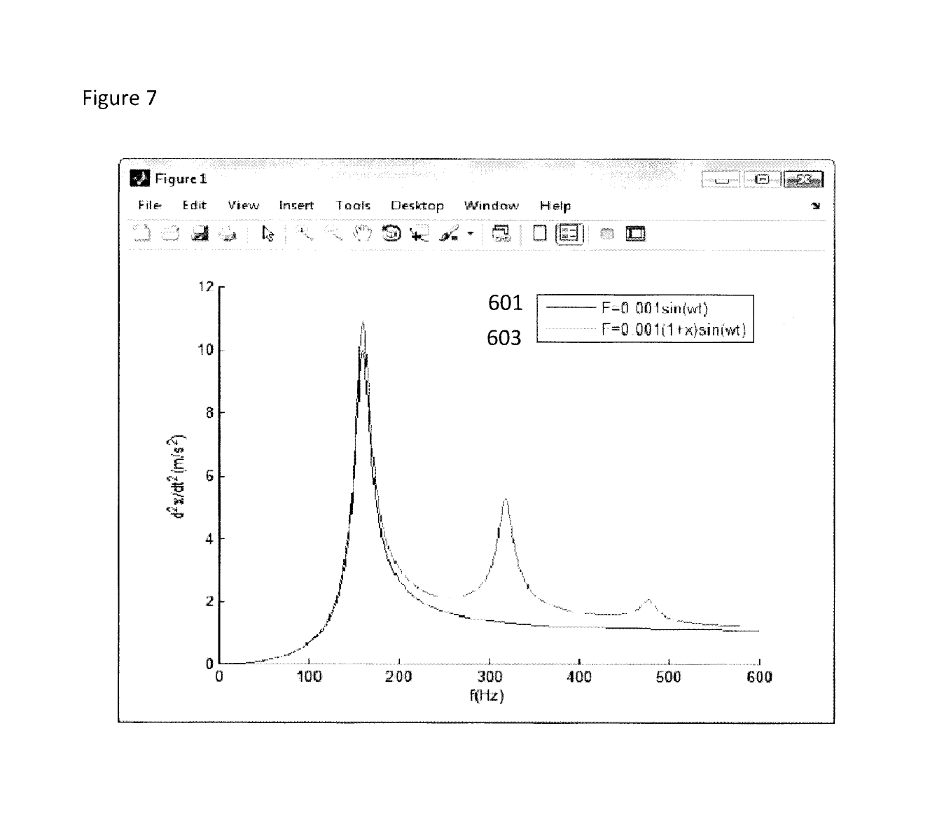

With respect to FIG. 7 a Matlab simulation plot can show the amplitude of acceleration against frequency plot 601 for the linear equation (for the example embodiments) and an amplitude of acceleration against frequency plot 603 for the non-linear equation. The non-linear equation can for example be evaluated as a Fourier series: X=x1*sin(ωt+theta1)+x2*sin(2ωt+theta2)+x3*sin(3ωt+theta3)+ . . . and ignore the orders above the 3^{rd} order. Furthermore the coefficients can also be solved out by equaling the different harmonic frequencies.

In the example plots for the non-linear force, acceleration is high enough (plot curve 603) to generate a second harmonic mode, while the linear force have low and flat curves (plot curve 601) at high harmonic modes. Similarly the same principle can be shown when the non-linear force is any type of function of distance x. In such examples the force can be expanded as a Taylor series F=(K0+k1*x+K2*x̂2+k3*x̂3 . . . )*sin(ωt) and solved for the amplitude of acceleration.

In some embodiments to simplify the production process, the resonance system comprising the resonance spring 207 and resonance weight 209 can be fixed to a plastic support by an insert metal process such as can be seen in FIG. 8.

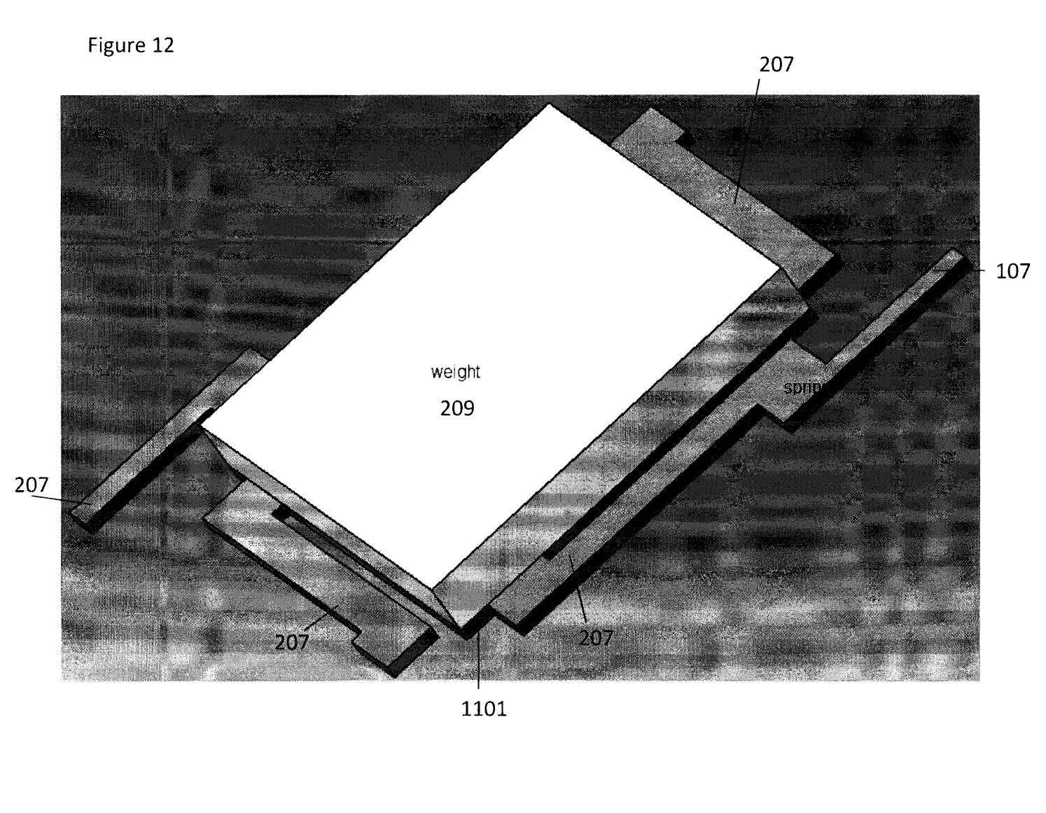

Furthermore in some embodiments additional weight can be added to the resonance weight 209 according to a design target by laser welding or gluing additional components to the base resonance weight 209 such as shown in FIG. 12.

It would be understood that the linear vibrator and manufacture of the linear vibrator according to some embodiments will be quite simple since there is no resonant magnet, or top plate, or yoke.

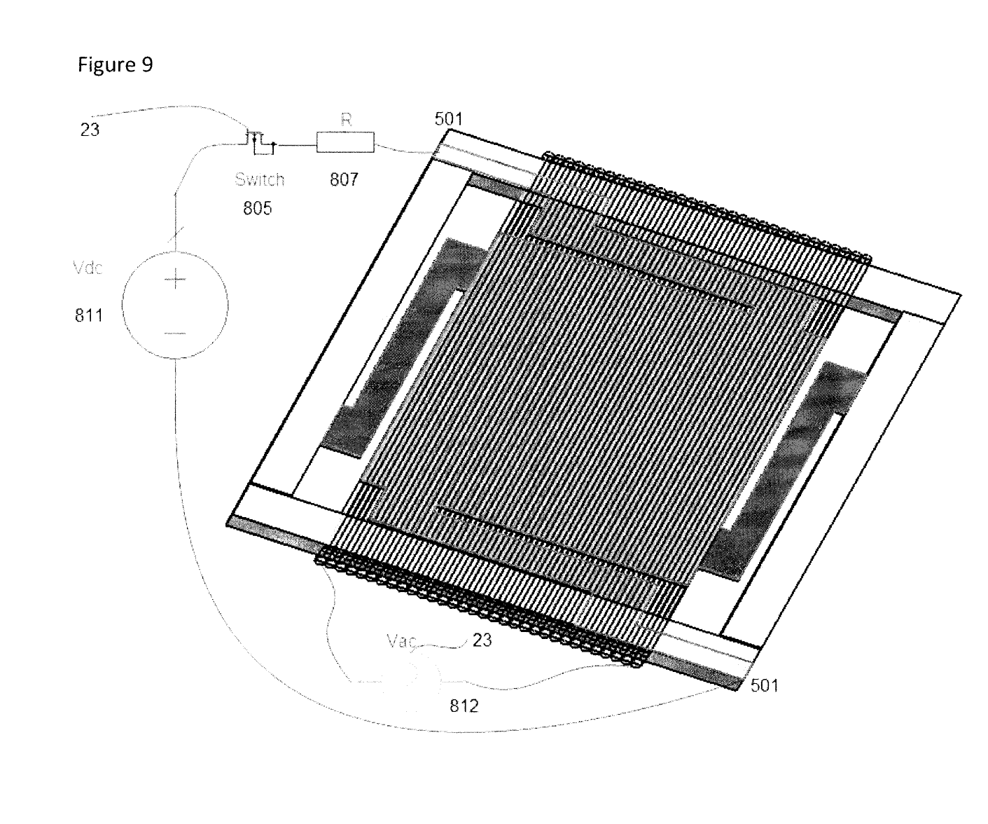

With respect to FIG. 9 an example electrical integration for the linear vibrator according to some embodiments. The example integration is shown in FIG. 9 uses a direct current voltage supply 811 coupled to the conductive arms of the resonance system via a MOSFET switch 805, a serial resister 807 and a DC supply 811 to provide the current through the weight with coupling to the terminals 501. DC supply 811 is usually a battery. An AC supply 812 will provide the AC signal with the same frequency as resonance system to the coil to generate the magnetic field as driving signal. The AC supply 812 can in some embodiments be a commercial amplifier or haptic driver. Furthermore in some embodiments both the AC supply 812 and the MOSFET switch 805 can be controlled, in other words enabled or disabled, by the processor running a suitable program code 23 depending on if the vibrator function is needed or not needed.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-20. (canceled)

21. An apparatus comprising:
a resonance module located within a resonator frame, the resonance module comprising at least two conductive suspension parts, the at least two conductive suspension parts being configured to:
couple the resonance module to the resonator frame; and
provide a current through the resonance module, wherein the at least two conductive suspension parts enable the resonance module to resonate.

22. The apparatus as claimed in claim 21, wherein the at least two conductive suspension parts are configured to be mechanically resilient in at least a direction substantially perpendicular to the direction of the current such that the resonance module is configured to have a static resting position.

23. The apparatus as claimed in claim 21, wherein the resonance module is a unitary body.

24. The apparatus as claimed in claim 21, wherein the resonance module comprises at least a conductive part wherein a weight of the at least the conductive part is a resonance weight.

25. The apparatus as claimed in claim 21, further comprising a conductive coil wrapped around the resonator frame and configured to generate a magnetic field in a first direction within the resonator frame when an alternating current passes through the conductive coil.

26. The apparatus as claimed in claim 25, wherein the alternating current passes through the resonance module in a second direction, the second direction at least partially perpendicular to the first direction.

27. The apparatus as claimed in claim 26, wherein the at least two conductive suspension parts are mechanically resilient in a third direction substantially perpendicular to the first and the second directions such that the resonance module is configured to resonate in the third direction based on the interaction of the magnetic field in the first direction and the second direction.

28. The apparatus as claimed in claim 21, wherein the resonator frame comprises at least two connectors configured to couple the at least two conductive suspension parts to a peripheral frame element.

29. The apparatus as claimed in claim 21, further comprising:
a series resistor;
a switch; and
a direct current voltage supply coupled via the series resistor and the switch in series to the at least two suspension parts to provide an intermittent current to drive the resonance module to resonate.

30. The apparatus as claimed in claim 25, further comprising a surround configured to partially surround and mechanically protect the resonance module, wherein the surround comprises:
an open box casing to substantially enclose the resonance module; and
a printed wiring board box lid.

31. The apparatus as claimed in claim 30, wherein the printed wiring board box lid comprises at least two conductive pads, and the at least two conductive pads are coupled to the at least two conductive suspension parts to drive the resonance module.

32. The apparatus as claimed in claim 30, wherein the printed wiring board box lid comprises the conductive coil wrapped around the resonator frame configured to generate a magnetic field within the resonator frame when an alternating current passes through the conductive coil.

33. The apparatus as claimed in claim 21, wherein the resonance module comprises a resonance weight coupled to the resonance frame by the at least two conductive suspension parts in such a way that the resonance weight and the at least two conductive suspension parts are joined together.

34. The apparatus as claimed in claim 33, wherein the resonance weight and the at least two conductive suspension parts are formed as one component.

35. The apparatus as claimed in claim 33, wherein the at least two conductive suspension parts are formed from a different material comparing to a material of the resonance weight.

36. A method comprising:
providing a resonance module located within a resonator frame, the resonance module comprising at least two conductive suspension parts;
coupling the at least two integrated conductive suspension parts to the resonance frame; and
providing a current through the resonance module, wherein the at least two conductive suspension parts enable the resonance module to resonate.

37. The method as claimed in claim 36, wherein the method comprises providing the at least two conductive suspension parts as mechanically resilient and in at least a direction substantially perpendicular to the direction of the current such that the resonance module has a static resting position.

38. The method as claimed in claim 36, wherein providing the at least two conductive suspension parts comprises mechanically coupling the resonance module to the resonance frame.

39. The method as claimed in claim 36, the method further comprising generating a magnetic field in a first direction within the resonance frame when an alternating current passes through a conductive coil wrapped around the resonator frame, wherein the current passes through the resonance module in a second direction, the second direction at least partially perpendicular to the first direction.

40. The method as claimed in claim 39, wherein the at least two conductive suspension parts are mechanically resilient in a third direction substantially perpendicular to the first and the second directions, the method further comprising resonating the resonance module in the third direction based on the interaction of the magnetic field in the first direction and the second direction.
